(19) United States
(12) Patent Application Publication
(10) Pub. No.: US 2025/0360856 A1
(43) Pub. Date: Nov. 27, 2025

(54) HEAD SUPPORT FOR VEHICLE SEAT

(71) Applicant: Bobbie-Jean NEWTON, Nelson (CA)

(72) Inventor: Bobbie-Jean NEWTON, Nelson (CA)

(21) Appl. No.: 19/215,049

(22) Filed: May 21, 2025

Related U.S. Application Data
(60) Provisional application No. 63/651,131, filed on May 23, 2024.

(51) Int. Cl. B60N 2/882; A47G 9/10; B60N 2/885

(52) U.S. Cl. CPC B60N 2/882; A47G 9/1045; B60N 2/885

(57) ABSTRACT

Head supports for a vehicle seat include a cushioned pillow assembly having a padded body and a locking mechanism; and a bracket assembly mountable to the seat. The head supports further include a strap assembly supporting a track assembly mounted thereon to allow positional adjustment and locking of the padded body to the strap assembly. The head supports further include a hair protection casing which partially encases the track assembly to prevent entanglement of the user's hair with components of the track assembly.

### CROSS REFERENCE TO RELATED APPLICATION

This application claims the benefit of U.S. Provisional Application Ser. No. 63/651,131 filed on May 23, 2024, entitled “HEAD SUPPORT FOR VEHICLE SEAT”, which is incorporated herein by reference in its entirety.

### FIELD OF THE INVENTION

The present invention relates to a head support for a seat, particularly a seat for a vehicle.

### BACKGROUND OF THE INVENTION

A seat for a vehicle generally includes a seat cushion supporting the hips, a seat back supporting the back of the passenger, and a headrest supporting the neck and head of the passenger. The seat back provides supporting force to the back and waist portions for a passenger's comfort. The headrest supports a passenger's neck and head to provide comfort to the neck, and protection by preventing abrupt movement of the head backward. However, the headrest can be uncomfortable, particularly when the headrest is formed of a firm material or cannot be adjusted to suit the needs of the passenger, especially one of short stature or a child. Further, headrests may not provide adequate support for napping passengers whose heads may have dropped to one side. The headrest may have components which can entangle or trap hair or clothing. A child may become agitated when uncomfortably seated in a vehicle, distracting the parent from driving safely. Accordingly, there remains a need for improved head supports which may overcome many of these shortcomings and provide a cost-effective solution.

### SUMMARY OF THE INVENTION

The present invention relates to a head support for a seat of a vehicle.

Broadly, in one aspect, the invention comprises a head support for a seat comprising a cushioned pillow assembly comprising a padded body and a locking mechanism; and a bracket assembly mountable to the seat.

In some embodiments, the padded body comprises a casing and a fill stuffed within the casing. In some embodiments, the casing is formed of a soft textile or synthetic material selected from cotton, viscose, lyocell, polyester, acrylic, silk, or blend. In some embodiments, the fill is formed of a material selected from memory foam, down, down alternative, feathers, latex, gel, kapok, wool, microbeads, or buckwheat. In some embodiments, the padded body is in the form of an animal or a character.

In some embodiments, the locking mechanism comprises a peg and a slidable plate, the peg being anchored within the padded body and extending outwardly from the padded body to the slidable plate. In some embodiments, the slidable plate defines a central aperture for receiving the peg therethrough, and is configured to be inserted into, or removed from, the bracket assembly.

In some embodiments, the bracket assembly comprises a track, a top portion, and a flexible prong. In some embodiments, the track comprises a flat body having a front surface, a back surface, opposing first and second ends, opposing first and second lengthwise sides, and a plate-retaining mechanism positioned on the front surface of the body. In some embodiments, the plate-retaining mechanism comprises a pair of rails defining a channel extending from the first end to the second end of the track.

In some embodiments, the track defines a plurality of openings spaced apart and extending between the first and second ends along the length of the track, each opening being configured to engage the peg.

In some embodiments, the top portion is positioned perpendicularly and horizontally relative to the track, the top portion being configured with a length sufficient to span a width of the seat.

In some embodiments, the flexible prong is positioned at an angle less than perpendicular and vertically relative to the top portion, the flexible prong being curved and configured with a length sufficient to span a portion of the seat.

Broadly, in another aspect, the invention comprises a head support for a seat comprising a cushioned pillow assembly comprising a padded body and a locking mechanism; a bracket assembly mountable to the seat; and a strap assembly supporting a track assembly mounted thereon.

In some embodiments, the bracket assembly comprises a head rest bracket comprising an elongated body defining a plurality of openings and a slot for receiving spokes of a vehicle head rest therethrough, and first and second ends supporting first and second tabs for attaching the strap assembly.

In some embodiments, the strap assembly comprises a strap, a snap fitting for removably attaching the strap assembly to the head rest bracket, an adjustable buckle for shortening or lengthening the strap, and a hook for securing the strap to an anchor of the seat.

In some embodiments, the snap fitting is selected from:
(a) a bracket defining a central window configured to receive the first or second tabs of the head rest bracket therethrough;
(b) a cantilever snap comprising a cantilever beam and an overhang at the end of the beam;
(c) a cantilever snap comprising a plate, a protrusion configured for insertion into a first recess defined by the head rest bracket, and a rod configured for insertion into a second recess defined by the head rest bracket; or
(d) the cantilever snap of (c) wherein the plate comprises a first magnet attractable to a second magnet with the first recess of the head rest bracket.

In some embodiments, the track assembly comprises a track and a track follower, the track comprising a flat body having a front surface, a back surface, first and second ends, and first and second sides defining notches.

In some embodiments, the head support further comprises attachment means and locking members for securing the track to the strap.

In some embodiments, the track follower is mountable to the track for translation along the track in a direction generally parallel to a longitudinal centerline of the track, the position of the track follower being selectively adjustable.

In some embodiments, the track follower is selected from:
(a) the track follower defining a pair of opposed inverted “L”-shaped slots, a pair of opposed fingers for engaging the notches, and a pair of opposed channels disposed on a rear surface for engaging the track, and a pair of outwardly extending opposed snap tabs on a front surface for attaching the cushioned pillow assembly;
(b) a buckle track follower; or
(c) a fabric track follower.

In some embodiments, the locking mechanism comprises an aperture plate positioned on a back of the padded body, and defining one or more apertures for receiving the snap tabs of the track follower, and optionally a flap for concealing the aperture plate.

In some embodiments, the head support further comprises a hair protection casing comprising an elongated body, curved ends encasing the first and second ends of the track, curved side walls encasing the sides of the track, and a rim extending around the body of the track, the hair protection casing defining an elongated window having a raised inner edge abutting the snap tabs.

Additional aspects and advantages of the present invention will be apparent in view of the description which follows. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a front perspective view of a first embodiment of the present invention mounted to the seat back of a vehicle and positioned adjacent a seated passenger.

FIG. 2 is a side perspective view of the embodiment shown in FIG. 1.

FIG. 3 is a back perspective view of the embodiment shown in FIG. 2, dismounted from the seat back.

FIG. 4 is a side perspective view of the embodiment shown in FIG. 2, dismounted from the seat back.

FIG. 5A is a front view of one embodiment of the bracket assembly, shown without the cushioned pillow assembly for clarity. FIG. 5B is a left front view of the embodiment of FIG. 5A. FIG. 5C is a left back view of the embodiment shown in FIG. 5A. FIG. 5D is a left side view of the embodiment shown in FIG. 5A.

FIG. 6A is a front perspective view of a second embodiment of the present invention mounted to the seat of a vehicle for positioning adjacent a seated passenger.

FIG. 6B is a front perspective view of the embodiment shown in FIG. 6A, showing installation of the head support and shown without the cushioned pillow assembly for clarity.

FIG. 7 is a front perspective view of one embodiment of a head rest bracket, one embodiment of a strap assembly, and one embodiment of a track assembly.

FIG. 8 is a front perspective view of one embodiment of a strap assembly.

FIG. 9 is a front perspective view of one embodiment of a snap fitting comprising a cantilever snap.

FIG. 10A is a front perspective view of one embodiment of a snap fitting comprising a cantilever snap being snap fit to a head rest bracket. FIG. 10B is a rear perspective view of the snap fitting of FIG. 10A. FIG. 10C is a top perspective view of the snap fitting of FIG. 10A snap fitted to the head rest bracket. FIG. 10D is a cross-sectional view of a portion of FIG. 10C taken along line A-A. FIG. 10E is a cross-sectional view of a portion of FIG. 10C taken along line A-A, showing the addition of magnets.

FIG. 11A is a front perspective view of one embodiment of a track. FIG. 11B is a front perspective view of the embodiment shown in FIG. 11A.

FIG. 12A is a front perspective view of one embodiment of a track follower. FIG. 12B is a front perspective view of the embodiment shown in FIG. 12A. FIG. 12C is a side end perspective view of the embodiment shown in FIG. 12A.

FIG. 13A is a front perspective view of one embodiment of a track assembly comprising a track and track follower. FIG. 13B is a front perspective view of the embodiment shown in FIG. 13A. FIG. 13C is an enlarged view of a portion of FIG. 13B. FIG. 13D is a side perspective view of the embodiment shown in FIG. 13A. FIG. 13E is a side end perspective view of the embodiment shown in FIG. 13A.

FIG. 14A is a back perspective view of one embodiment of a cushioned pillow assembly comprising a flap. FIG. 14B is a front perspective view of the embodiment shown in FIG. 14A, to which a track assembly is being mounted. FIG. 14C is a back perspective view of the embodiment shown in FIG. 14B, showing a locking mechanism to which the track assembly is being mounted. FIG. 14D is a back perspective view of the embodiment shown in FIG. 14C, showing the track assembly mounted to the locking mechanism. FIG. 14E is a front perspective view of the embodiment shown in FIG. 14D. FIG. 14F is a cross-sectional side view taken along line B-B of the embodiment shown in FIG. 14E. FIG. 14G is an enlarged portion of FIG. 14F.

FIG. 15A is a front perspective view of a second embodiment of a strap assembly and track follower. FIG. 15B is a front perspective view of a third embodiment of a strap assembly and track follower.

FIG. 16A is a front perspective view of one embodiment of a hair protection casing. FIG. 16B is a side end perspective view of the embodiment shown in FIG. 16A. FIG. 16C is a front perspective view of the embodiment shown in FIG. 16A. FIG. 16D is a side perspective view of the embodiment shown in FIG. 16A. FIG. 16E is a cross-sectional side view taken along line A-A of the embodiment shown in FIG. 16C.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. The term “horizontal” means the orientation of a plane or line that is substantially parallel to the plane of the horizon. The term “vertical” means the orientation of a plane or line that is substantially at a right angle to the horizontal plane. The terms “front” and “back” are used to describe the positions of various components of the head support. The term “front” refers to a position towards a passenger's neck and head. The term “back” refers to a position away from a passenger's neck and head.

The present invention relates to embodiments of a head support that can be attached to a standard seat of any vehicle for carrying or transporting an adult or child passenger. The embodiments of the head support provide support for the neck and head of the passenger when the head rests directly upon the head support or when the head leans to one side when the passenger is sleeping. Suitable vehicle seats for use with the invention include, but are not limited, seats of automobiles, trucks, buses, airplanes, trains, and the like. While the embodiments of the head support disclosed herein are discussed in the context of use for a vehicle seat, the skilled person will appreciate that the embodiments of the head support may be suitable for use with other types of seats including, but not limited to, booster seats, highchairs, strollers, prams, chairs, sofas, couches, benches, and the like.

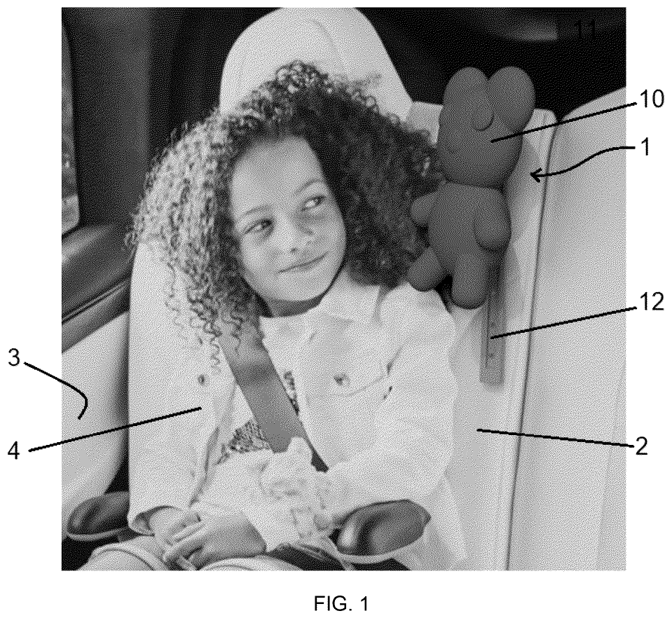

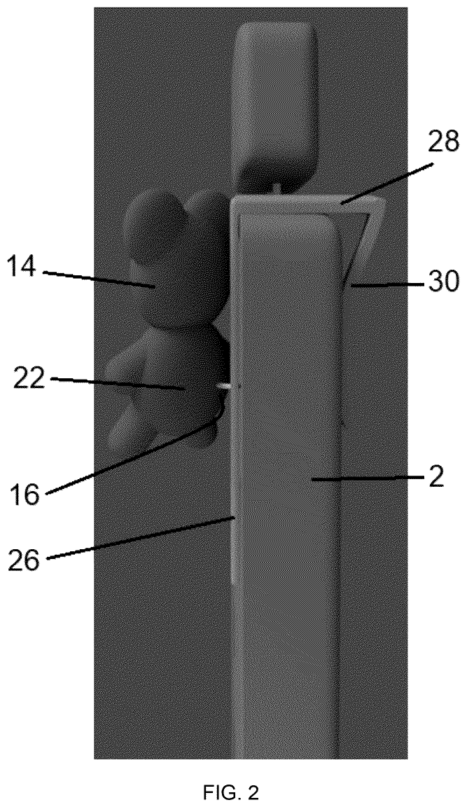

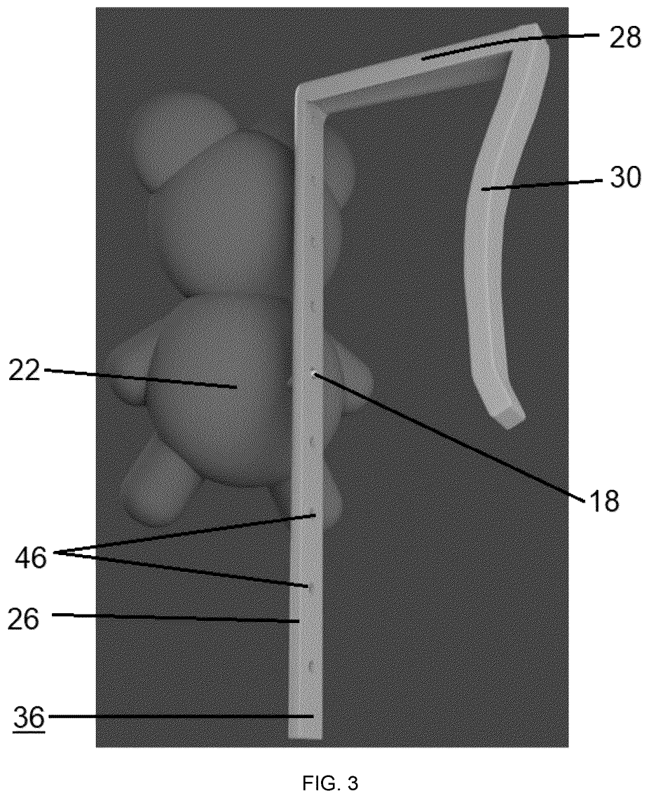

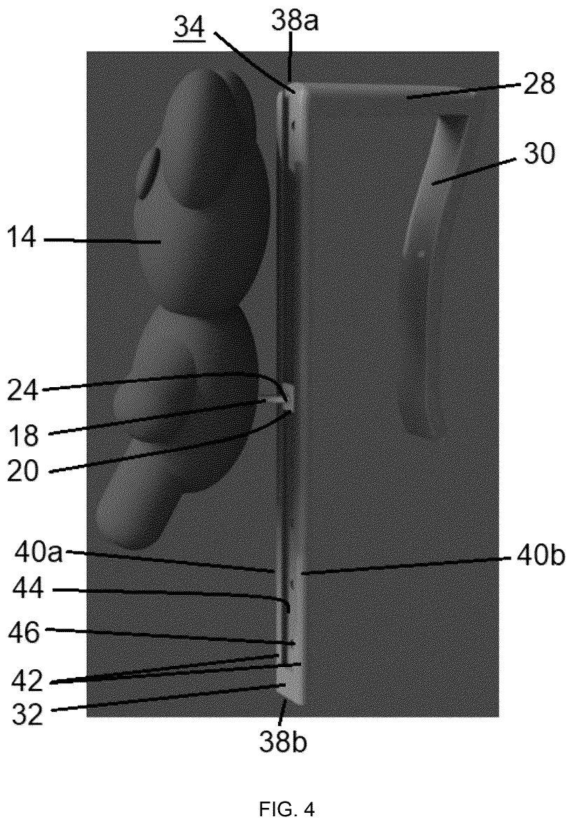

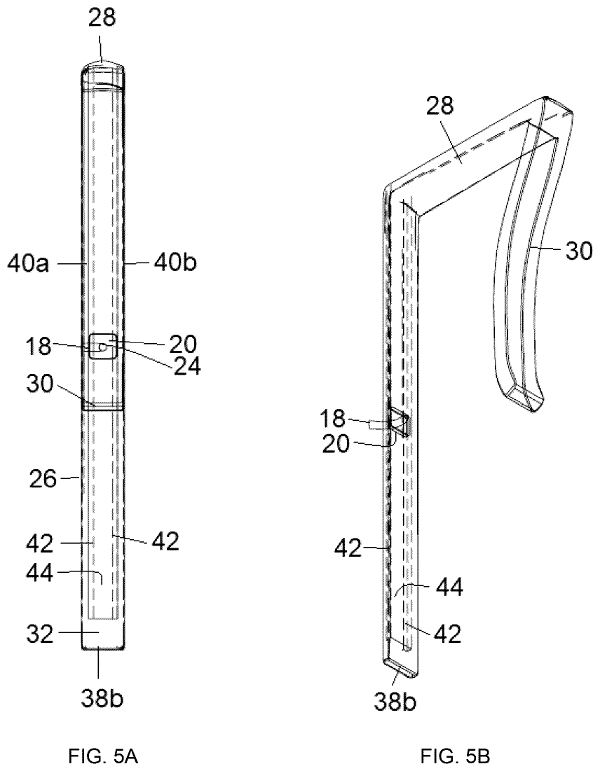

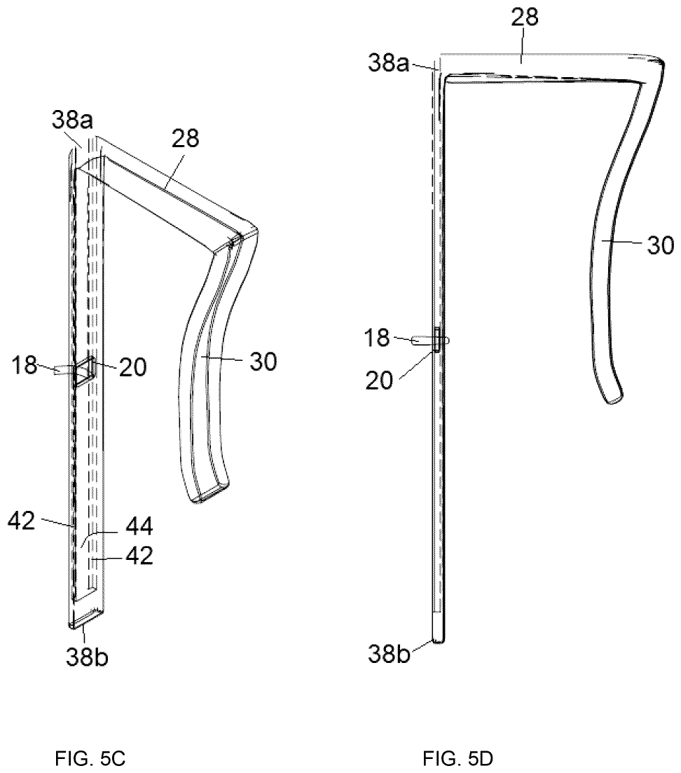

Embodiments of the invention will now be described having reference to the accompanying Figures. In a first embodiment, the head support (1) of the present invention is shown attached to the seat back (2) of a vehicle (3) in FIGS. 1 and 2. The head support (1) is positioned adjacent or close to the seated passenger (4) to provide direct support, or left or right side support for the neck and head. The head support (1) is shown dismounted from the seat back (2) in FIGS. 3 and 4 to show all its components in detail. The head support (1) is shown partially in FIGS. 5A-D to show specific components in detail.

The head support (1) is shown generally in FIGS. 1-4 to comprise a cushioned pillow assembly (10) and a bracket assembly (12). In some embodiments, the cushioned pillow assembly (10) comprises a padded body (14) and a locking mechanism (16). In some embodiments, the padded body (14) comprises a casing and a fill stuffed within the casing. In some embodiments, the casing may be formed of a soft textile or synthetic material including, but not limited to, cotton, viscose, lyocell, polyester, acrylic, silk, and blends. In some embodiments, the fill may be formed of materials including, but not limited to, memory foam, down, down alternative, feathers, latex, gel, kapok, wool, microbeads, and buckwheat. In some embodiments, the padded body (14) is in the form of a stuffed animal such as a teddy bear (as shown in FIGS. 1-4) or a popular animated character for use as a travel companion or comfort object suitable for a child passenger. Parents can concentrate on driving safely without worrying about checking on their child. The padded body (14) serves as a pillow upon which the passenger can rest the neck and head.

In some embodiments as shown in FIGS. 4-5D, the locking mechanism (16) comprises a peg (18) and a slidable plate (20). In some embodiments, the peg (18) is configured to be anchored within the padded body (14) and to extend outwardly from the back (22) of the padded body (14) to the slidable plate (20). The slidable plate (20) defines a central aperture (24) for receiving the peg (18) therethrough. The slidable plate (20) is configured to be inserted into, or removed from, the bracket assembly (12). In some embodiments, the slidable plate (20) has a substantially square or rectangular shape. In some embodiments, the peg (18) and slidable plate (20) be formed of plastic using plastic extrusion or molding processes. In some embodiments, the peg (18) and slidable plate (20) may be formed of metal including, but not limited to, aluminum.

In some embodiments, the bracket assembly (12) comprises a length of track (26), a top portion (28), and a flexible prong (30). In some embodiments, the track (26), top portion (28), and flexible prong (30) together form a “hook” shape. The track (26) comprises a generally flat body (32) having a front surface (34), a back surface (36), opposing first and second ends (38a, 38b), and opposing first and second lengthwise sides (40a, 40b). In some embodiments, the body (32) has a substantially rectangular shape.

The track (26) further comprises a plate-retaining mechanism positioned on the front surface (34) of the body (32) to anchor the slidable plate (20) to the front surface (34) of the track (26). In some embodiments, the plate-retaining mechanism comprises a pair of rails (42) which define a channel (44) extending from the first end (38a) to the second end (38b) of the track (26). In some embodiments, the rails (42) extend outwardly and perpendicularly from the front surface (34) of the body (32). The rails (42) are oriented to extend between the opposing first and second ends (38a, 38b) along the entire length of the first and second lengthwise sides (40a, 40b). The rails (42) are spaced parallel and apart from each other to form the channel (44) therebetween for receiving the slidable plate (20). The lips of the rails (42) delimit the channel (44) between them for anchoring the slidable plate (20) within the channel (44).

In some embodiments, the track (26) further defines a plurality of openings (46) which are spaced apart and extend between the opposing first and second ends (38a, 38b) along the entire length of the track (26). Each opening (46) is configured to engage the peg (18), thereby providing different positions at which the cushioned pillow assembly (10) can be positioned along the bracket assembly (12) and accommodating various heights of any seated passengers.

In some embodiments, the top portion (28) is positioned perpendicularly and horizontally relative to the track (26). In some embodiments as shown in FIG. 2, the top portion (28) is configured with a length sufficient to span the width of a standard seat back (2). In some embodiments, the top portion (28) is configured to have an adjustable length in order to accommodate the width of any seat back (2) which may not be of standard width; for example, the seat back of a baby highchair has a narrower width than a standard seat back (2) of a vehicle (3). In some embodiments, the top portion (28) is configured to comprise a plurality of collapsible joints such as accordion elbows or pleats so as to enable shortening or lengthening of the top portion (28) in order to accommodate the width of any seat back.

In some embodiments, the flexible prong (30) is positioned at an angle less than perpendicular and vertically relative to the top portion (28). In some embodiments as shown in FIG. 2, the flexible prong (30) is curved and configured with a length sufficient to span a portion of the length of a standard seat back (2), thereby ensuring that the head support (1) is securely mounted to the seat back (2). In some embodiments, the flexible prong (30) has a length which is about half the length of the track (26). The flexibility of the prong (30) allows it to press against the seat back (2), thereby securely clipping the head support (1) onto the seat back (2).

In some embodiments, the track (26), top portion (28) and flexible prong (30) may be formed of plastic using plastic extrusion or molding processes. In some embodiments, the track (26), top portion (28) and flexible prong (30) may be formed of metal including, but not limited to, aluminum.

Components of the head support (1) can be constructed from any materials or combinations of materials having suitable properties such as, for example, flexibility, durability, resistance to wear and tear, weight, and ease of manufacture. The dimensions are not essential to the invention and are dictated by the various sizes, dimensions, and shapes of the components. The dimensions may be increased or decreased as may be required to satisfy any particular design objectives.

In operation, the head support (1) is installed by securing the bracket assembly (12) over either the left or right side of the seat back (2), with the track (26) facing towards the passenger and the flexible prong (30) pressing against the seat back (2). The track (26) and flexible prong (30) together grip the seat back (2). To secure the cushioned pillow assembly (10) to the bracket assembly (12), the slidable plate (20) is placed at the first end (38a) of the track (26), and is slid within the channel (44) formed by the rails (42) to the desired position or opening (44) between the first and second ends (38a, 38b) of the track (26). When the slidable plate (20) is at the desired position or opening (44), the peg (18) is passed through the central aperture (24) of the slidable plate (20) and the opening (44) of the track (26).

The cushioned pillow assembly (10) is attached to the bracket assembly (12) at the appropriate height for the passenger to rest the neck and head in a natural, comfortable position, or in a supported position (as when the passenger falls asleep), minimizing the risk of head bobbing or neck strain. The positioning of the cushioned pillow assembly (10) can be easily and readily adjusted for either adults or children. In some embodiments, the bracket assembly (12) may be a “one size fits all” for use with a variety of different designs of the cushioned pillow assembly (10) appropriate for either adults (e.g., larger sizes, branded sport pillows) or children (e.g., smaller sizes, animals, popular animated characters). The cushioned pillow assembly (12) is interchangeable, being conveniently changed out as desired. In some embodiments, the head support (1) may be packaged in a kit form including one particular design of the cushioned pillow assembly (10) and the bracket assembly (12). Other designs of the cushioned pillow assembly (10) may be purchased separately for attachment to the originally purchased bracket assembly (12).

It should be apparent, however, to those skilled in the art that many more modifications besides those already described are possible without departing from the inventive concepts herein.

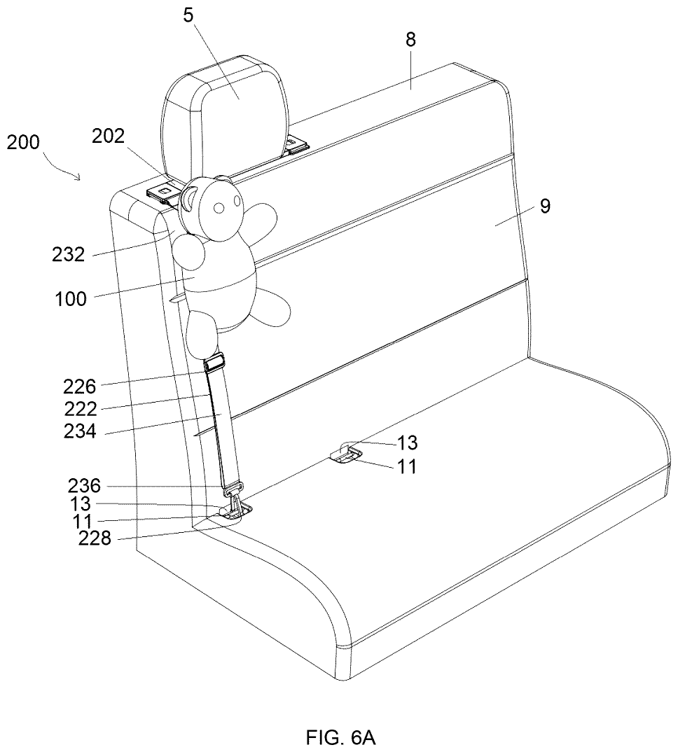

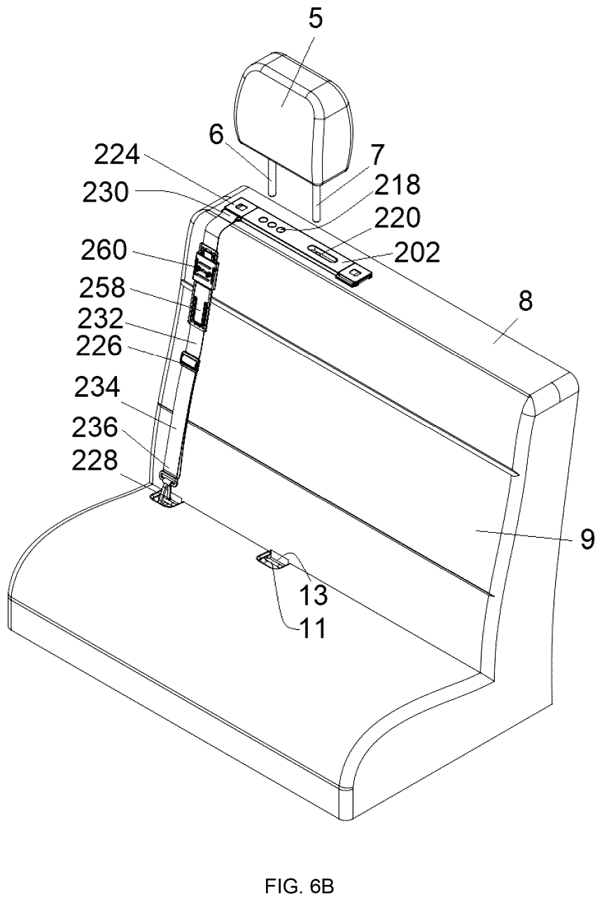

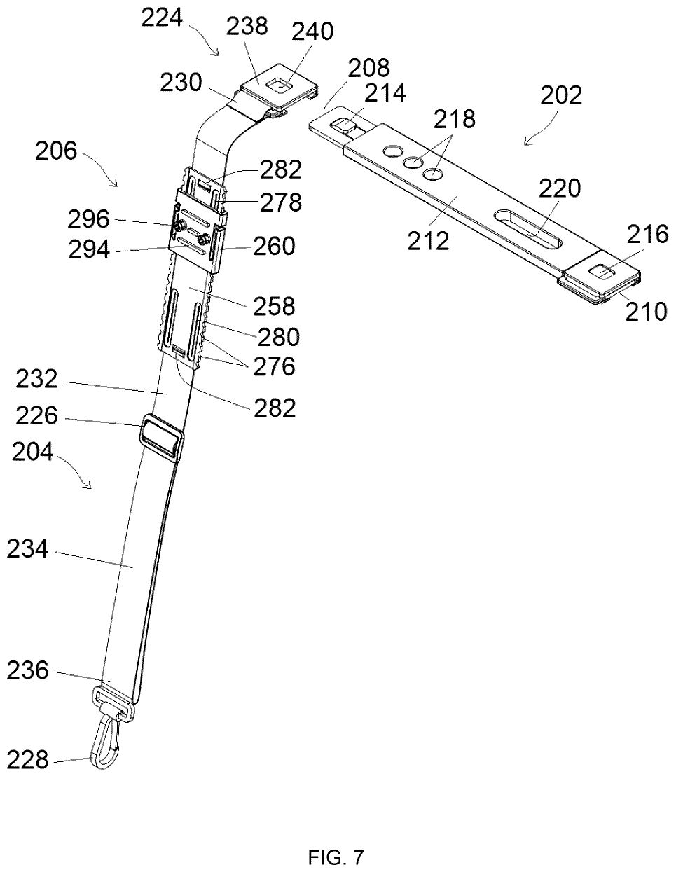

In a second embodiment, the head support (200) of the present invention is shown attached to the head rest (5) of a vehicle (3) in FIG. 6A. The head support (200) is positioned adjacent or close to the seated passenger (4) to provide direct support, or left or right side support for the neck and head. The head support (200) is shown partially dismounted from the head rest (5) in FIG. 6B to show specific components in detail. The head support (200) is shown partially in FIGS. 7-16E to show specific components in detail.

In some embodiments, the head support (200) is shown generally in FIGS. 6A-B to comprise a head rest bracket (202), a strap assembly (204), a track assembly (206), and a cushioned pillow assembly (100).

In some embodiments as shown in FIG. 7, the head rest bracket (202) comprises a first end (208), a second end (210), and a substantially rectangular elongated body (212) extending between the first and second ends (208, 210). Each of the first and second ends (208, 210) supports an upwardly extending first tab (214) and second tab (216), respectively, for attaching the strap assembly (204) at either the first or second ends (208, 210). The body (212) defines a plurality of spaced apart openings (218) adjacent to the first end (208), and a slot (220) adjacent to the second end (210). In some embodiments, there are three openings (218) and one slot (220). The openings (218) are configured to receive the left spoke (6) or the right spoke (7) of the head rest (5) therethrough, while the slot (220) is configured to receive the right spoke (7) of the head rest (5) therethrough (FIG. 6B) when the head rest (5) is installed on the top (8) of the seat (9). The openings (218) and slot (220) enable horizontal adjustment of the head support (200) along the top (8) of the seat (9) to provide direct support, or left or right side support for the neck and head.

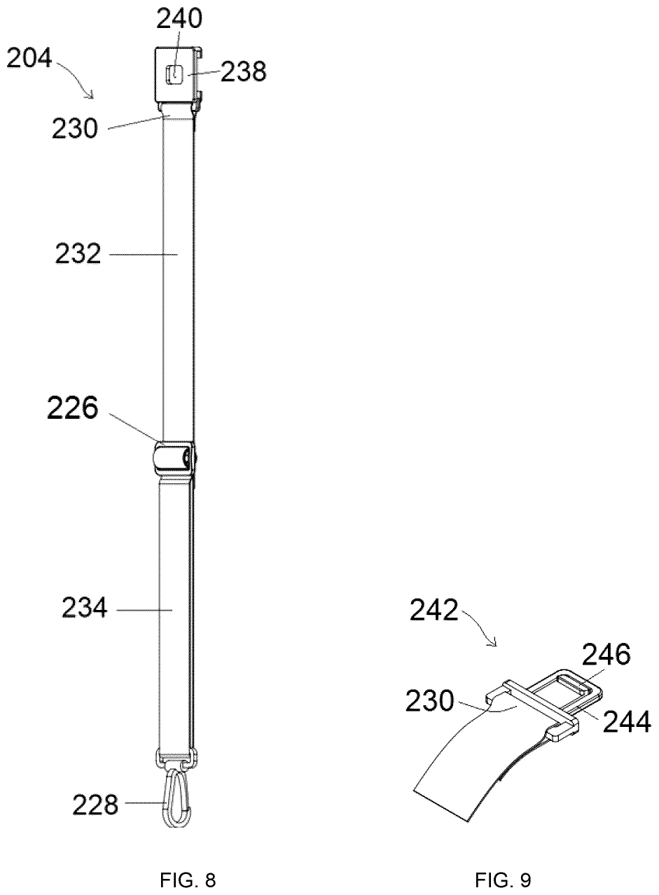

In some embodiments as shown in FIGS. 7 and 8, the strap assembly (204) comprises a strap (222), a snap fitting (224), an adjustable buckle (226), and a hook (228). The strap (222) comprises a top end (230), a top portion (232), a bottom portion (234), and a bottom end (236). In some embodiments, the strap (222) is formed of any material or combination of materials having suitable properties such as, for example, durability and resistance to wear and tear including, but not limited to, polyester webbing, cotton webbing, nylon, and the like.

Snap fitting allows quick fastening and release of the strap assembly (204) to the head rest bracket (202). In some embodiments, a snap fitting (224) at the top end (230) of the strap (222) attaches the strap assembly (204) to the head rest bracket (202). In some embodiments as shown in FIGS. 6B-8, the snap fitting (224) comprises a bracket (238) defining a central window (240) corresponding to the configuration of the first or second tab (214, 216) of the head rest bracket (202) for receiving the first or second tab (214, 216) therethrough. In some embodiments, the bracket (238) is substantially “C”-shaped in cross-section such that when the window (240) is pressed over the first or second tab (214, 216), the bracket (238) snap-fits to the first or second end (208, 210) of the head rest bracket (202), thereby securing the strap assembly (204) to the head rest bracket (202).

In some embodiments, the snap fitting (224) comprises a cantilever snap (242). In some embodiments as shown in FIG. 9, the cantilever snap (242) comprises a cantilever beam (244) and an overhang (246) at the end of the beam (244). The first or second ends (208, 210) of the head rest bracket (202) may be configured to mate with the overhang (246) in a snap-fit, thereby securing the strap assembly (204) to the head rest bracket (202).

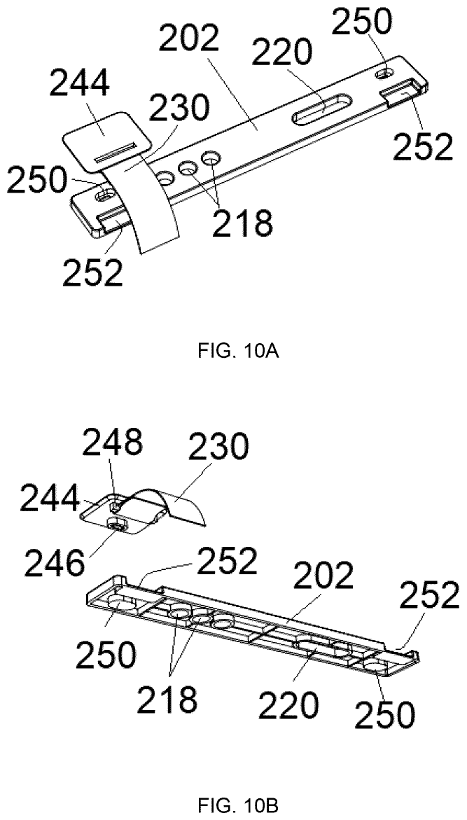

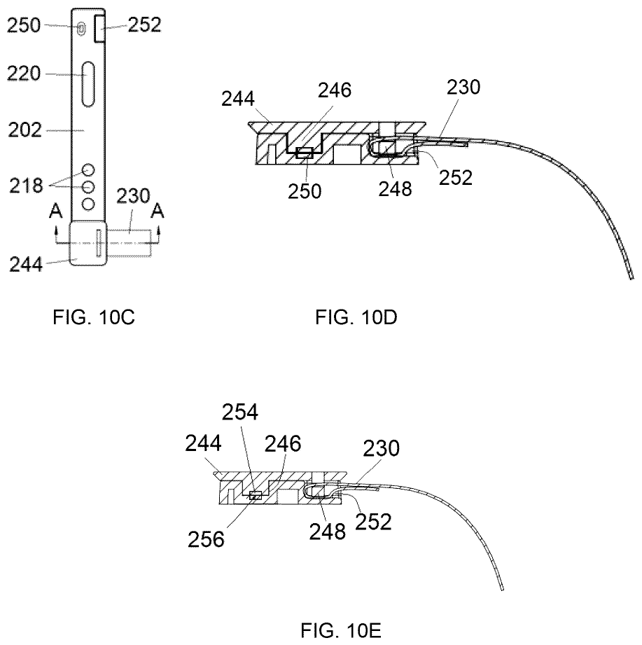

In some embodiments as shown in FIGS. 10A-D, the cantilever snap (242) comprises a plate (244), a protrusion (246), and a rod (248) holding the top portion (230) of the strap (222). The first end (208) of the head rest bracket (202) may be configured to define a corresponding first recess (250) for mating with the protrusion (246) and a corresponding second recess (252) for receiving the rod (248) in a snap-fit, thereby securing the strap assembly (204) to the head rest bracket (202).

In some embodiments as shown in FIG. 10E, the plate (244) comprises a first magnet (254). The first or second end (208, 210) of the head rest bracket (202) may be configured to support a second magnet (256) within the first recess (250). The first and second magnets (254, 256) are placed with opposite poles facing to be attracted together. When the plate (244) is positioned over the first end (208) of the head rest bracket (202), the first and second magnets (254, 256) are attracted together, preventing disassembly of the strap assembly (204) from the head rest bracket (202).

In some embodiments, the adjustable buckle (226) is adjustable along the length of the strap (222) for adjusting the length of the top portion (232) and bottom portion (234) of the strap (222). In some embodiments, the adjustable buckle (226) comprises a metal rectangle and slider piece. As per the normal operation of adjustable buckles (226), the top and bottom portions (232, 234) of the strap (222) can be pulled through the adjustable buckle (226) to shorten or increase the length of the strap (222).

In some embodiments as shown in FIGS. 6A-B, the hook (228) at the bottom end (236) of the strap (222) secures the bottom end (236) of the strap (222) to a lower anchor (11) hidden within the crack (13) of the seat (9). The lower anchor (11) comprises a metal U-shaped bar. There is typically a pair of lower anchors (11) within the crack (13) of the seat (9). In some embodiments, the hook (228) comprises a swivel snap hook.

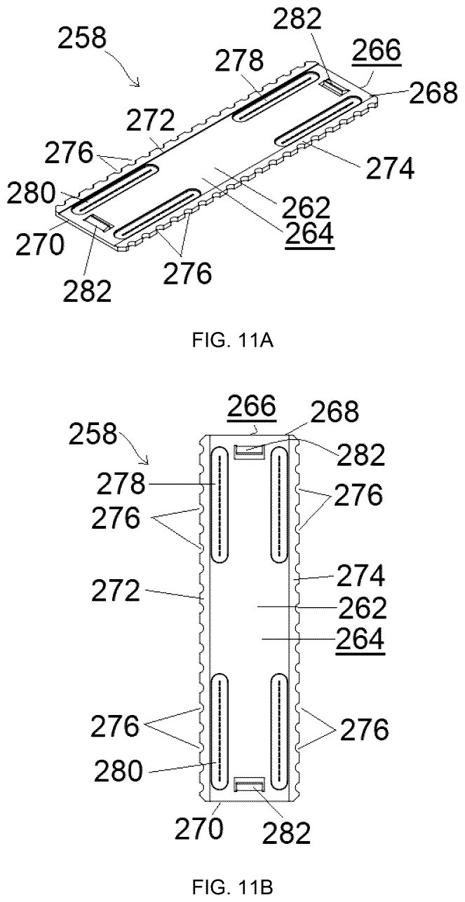

In some embodiments, the track assembly (206) comprises a track (258) and a track follower (260). In some embodiments as shown in FIGS. 11A-B, the track (258) comprises a generally flat body (262) having a front surface (264), a back surface (266), opposing first and second ends (268, 270), and opposing first and second lengthwise sides (272, 274). In some embodiments, the body (262) has a substantially rectangular shape. Each of the first and second sides (272, 274) comprises a plurality of spaced apart notches (276) extending along the entire length of the first and second sides (272, 274). The notches (276) of the first side (272) are aligned with corresponding notches (276) on the second side (274). The track (258) defines a first pair of opposed attachment means (278) adjacent to the first end (268) and a second pair of opposed attachment means (280) adjacent to the second end (270) for allowing the track (258) to be attached to the strap (222). In some embodiments, the attachment means (278, 280) comprise thinned portions of the track (258) which are sewn to the strap (222). Other suitable attachment means include, but are not limited to, sewing stitches, patches, bonding using adhesives, and the like.

In some embodiments, locking members (282) positioned at the first and second ends (268, 270) lock the track (258) to the strap (222) to prevent the track (258) from falling downwardly along the strap (222) or falling entirely off the strap (222).

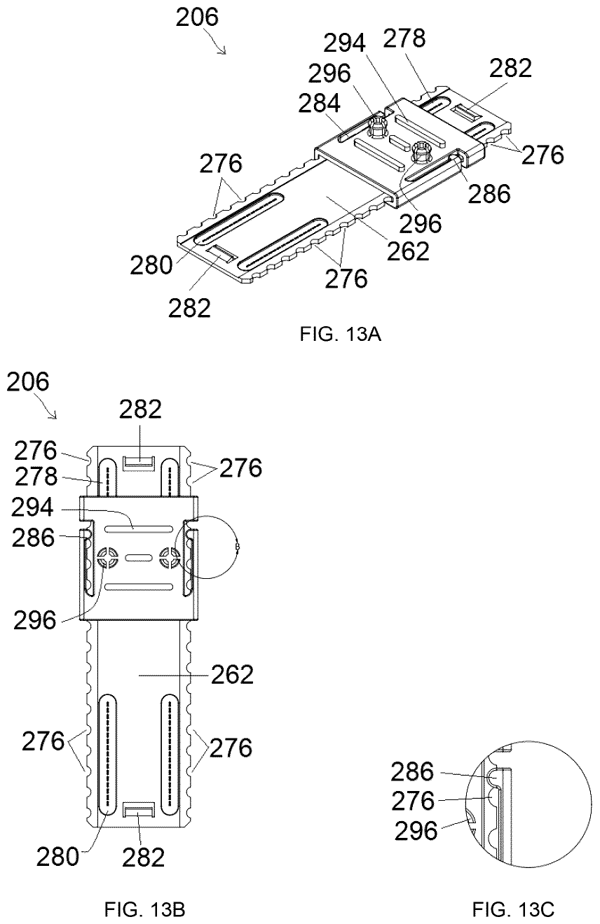

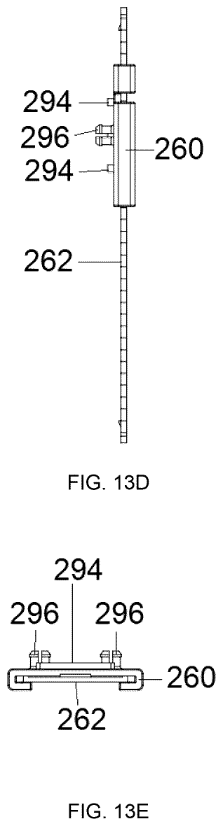

In some embodiments as shown in FIGS. 13A-E, the track follower (260) is configured to be mounted to the track (258) for translation along the track (258) in a direction generally parallel to the longitudinal centerline of the track (258). The track follower (260) is configured to ride along the track (258) between the opposing first and second ends (268, 270) of the track (258). The position of the track follower (260) is selectively adjustable by engaging any pair of opposed notches (276) along the length of the track (258).

In some embodiments, the track follower (260) is configured to engage the track (258). In some embodiments, the track follower (260) is substantially square-shaped. In some embodiments, the track follower (260) is substantially “C”-shaped in cross-section. In some embodiments, the track follower (260) has a sufficient width to engage the notches (276) of the track (258).

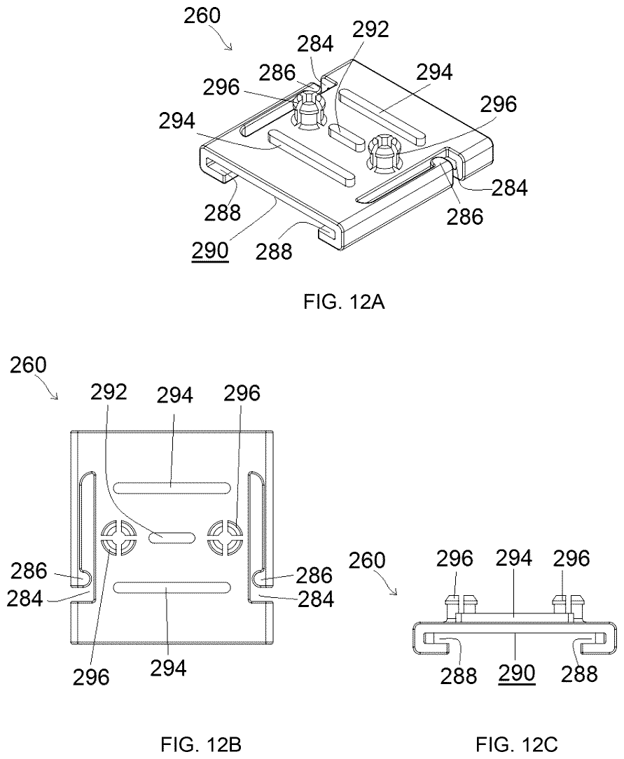

In some embodiments as shown in FIGS. 12A-C, the track follower (260) defines a pair of opposed inverted “L”-shaped slots (284), a pair of opposed fingers (286), and a pair of opposed channels (288) disposed on the rear surface (290) for engaging the track (258). The slots (284) reveal the notches (276) as the track follower (260) rides along the track (258), allowing the user to manipulate the fingers (286) to engage or disengage the corresponding notches (276) on the first and second sides (272, 274) of the track (258) to secure or release the track follower (260) in the desired position. In some embodiments, the track follower (260) may be formed of a flexible material using extrusion or molding processes. In some embodiments, the track follower (260) is formed of a flexible material including, but not limited to, synthetic and natural polymeric materials for example, nylon, polyester, polypropylene, polyethylene, and thermoplastics. The flexibility facilitates manipulation of the fingers (286) to engage or disengage the notches (276). In some embodiments, the track follower (260) supports a shorter central rib (292) and a pair of parallel aligned longer ribs (294). In some embodiments, the track follower (260) supports a pair of outwardly extending opposed snap tabs (296) on the front surface (264) for attaching the cushioned pillow assembly (100).

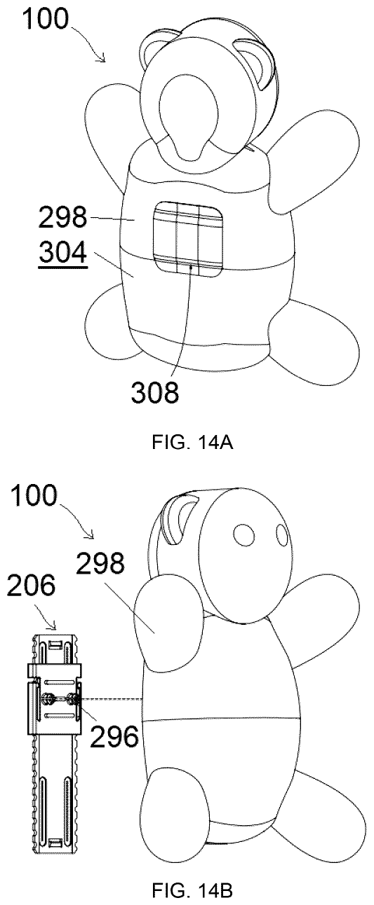

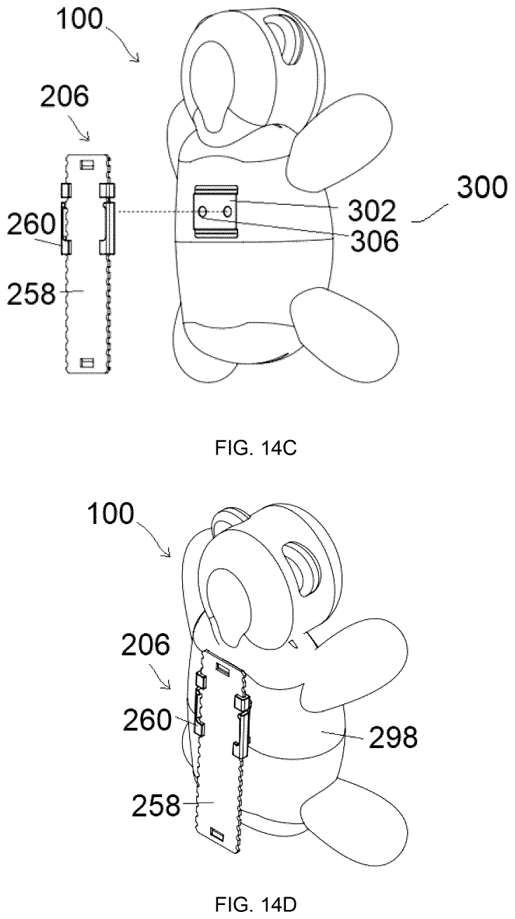

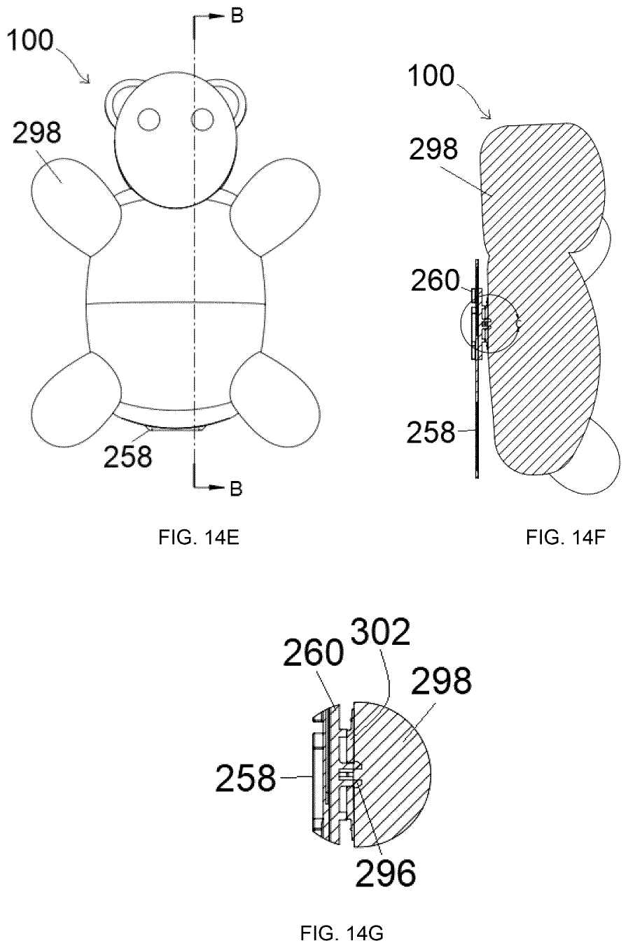

In some embodiments as shown in FIGS. 14A-G, the cushioned pillow assembly (100) comprises a padded body (298) and a locking mechanism (300). In some embodiments, the padded body (298) comprises a casing and a fill stuffed within the casing. In some embodiments, the casing may be formed of a soft textile or synthetic material including, but not limited to, cotton, viscose, lyocell, polyester, acrylic, silk, and blends. In some embodiments, the fill may be formed of materials including, but not limited to, memory foam, down, down alternative, feathers, latex, gel, kapok, wool, microbeads, and buckwheat. In some embodiments, the padded body (298) is in the form of a stuffed animal such as a teddy bear (as shown in FIGS. 14A-G) or a popular animated character for use as a travel companion or comfort object suitable for a child passenger. Parents can concentrate on driving safely without worrying about checking on their child. The padded body (298) serves as a pillow upon which the passenger can rest the neck and head.

In some embodiments as shown in FIG. 14C, the locking mechanism (300) comprises an aperture plate (302) which is positioned on the back (304) of the padded body (298). In some embodiments, the aperture plate (302) is configured to be anchored within the padded body (298). In some embodiments, the aperture plate (302) defines one or more apertures (306) for receiving the snap tabs (296) of the track follower (260) in a snap-fit, thereby securing the cushioned pillow assembly (100) to the track assembly (206).

In some embodiments as shown in FIG. 14A, the aperture plate (302) is concealed by a flap (308) formed of a soft textile or synthetic material and secured to the back (304) of the padded body (298) by suitable attachment means including, but not limited to, Velcro™ and the like. The provision of the flap (308) allows the cushioned pillow assembly (100) to be used as a toy for play by the child when it is not being used as a head support (200).

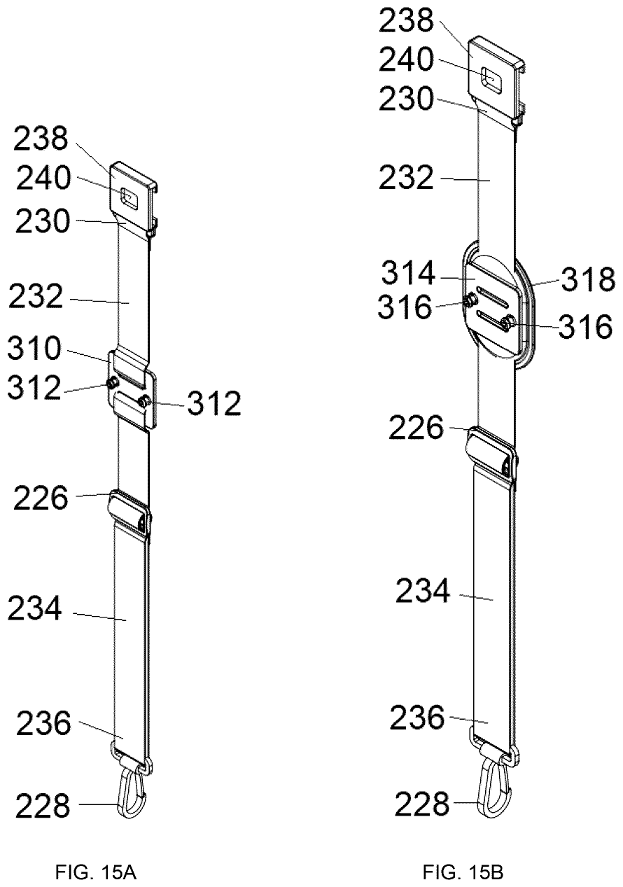

In some embodiments as shown in FIG. 15A, the track assembly (206) comprises a track follower (260) in the form of a buckle track follower (310). In some embodiments, the buckle track follower (310) comprises snap tabs (312) which mate with the corresponding apertures (306) of the aperture plate (302). The positioning of the buckle track follower (310) is adjusted by shortening or increasing the length of the strap (222) using the adjustable buckle (226).

In some embodiments as shown in FIG. 15B, the track assembly (206) comprises a track follower (260) in the form of a fabric track follower (314). In some embodiments, the fabric track follower (314) comprises snap tabs (316) which mate with the corresponding apertures (306) of the aperture plate (302). In some embodiments, the fabric track follower (314) is slidable along the strap (222) into the desired position. In some embodiments, the positioning of the fabric track follower (314) is adjusted by shortening or increasing the length of the strap (222) using the adjustable buckle (226).

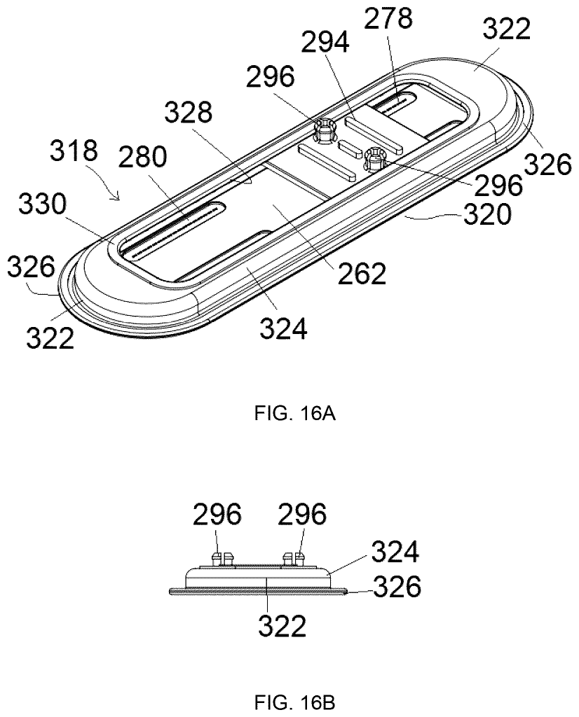

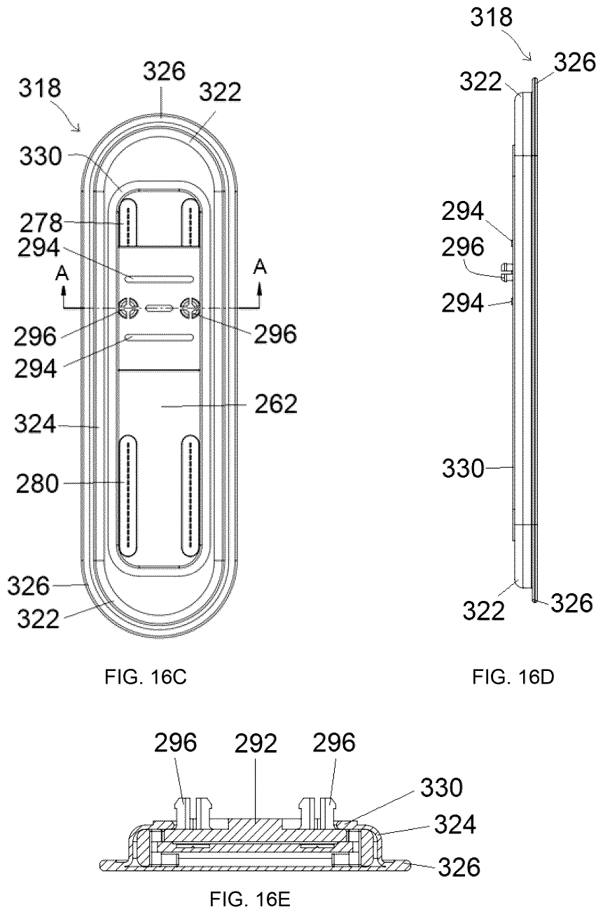

In some embodiments as shown in FIGS. 16A-E, the track assembly (206) further comprises a hair protection casing (318). In some embodiments, the hair protection casing (318) comprises an elongated body (320), curved ends (322), curved side walls (324), and a rim (326) extending around the entire perimeter of the body (320). In some embodiments, the hair protection casing (318) is substantially oval-shaped. The curved ends (322) and curved side walls (324) slope downwardly. The curved ends (322) fully encase the first and second ends (268, 270) of the track (258). The hair protection casing (318) defines an elongated window (328) having a raised inner edge (330), which provides access to the snap tabs (294, 312, 316) of the track follower (260, 310, 314). The rim (326) and curved side walls (324) fully encase the rear surface (290) and the notches (276) of the track (258). The raised inner edge (330) of the window (328) abuts the snap tabs (294, 312, 316) of the track follower (260, 310, 314). This abutment also ensures that there are no gaps between the track follower (260, 310, 314) and cushioned pillow assembly (100) when assembled. This abutment and the smooth, curved surfaces provided by the curved ends (322), curved side walls (324), and rim (326) in combination prevent entanglement of the user's hair with components of the track follower (260, 310, 314). In some embodiments, the hair protection casing (318) is formed of a flexible material including, but not limited to, synthetic and natural polymeric materials for example, nylon, polyester, polypropylene, polyethylene, and thermoplastics. The flexibility facilitates easy, quick attachment or removal of the hair protection casing (318) from the track (258).

Components of the head support (200) can be constructed from any materials or combinations of materials having suitable properties such as, for example, flexibility, durability, resistance to wear and tear, weight, and ease of manufacture. The dimensions are not essential to the invention and are dictated by the various sizes, dimensions, and shapes of the components. The dimensions may be increased or decreased as may be required to satisfy any particular design objectives. In some embodiments, the track assembly (206) is attached to the strap assembly (204) during manufacture ready for use. In some embodiments, the track assembly (206) is provided as a separate component which can be attached to the strap assembly (204) using the locking members (282).

In operation, the head support (200) is installed by attaching the assembled strap assembly (204) and track assembly (206) to the head rest bracket (202) using the snap fit means. In some embodiments as shown in FIGS. 6B-8, the window (240) of the bracket (238) is pressed over the first or second tab (214, 216) of the head rest bracket (202) to snap-fit the strap assembly (204) to the head rest bracket (202). In some embodiments as shown in FIGS. 9-10D, the cantilever snap (242) is used to snap-fit the strap assembly (204) to the head rest bracket (202). In some embodiments as shown in FIG. 10E, the cantilever snap (242) and first and second magnets (254, 256) are used to snap-fit and secure the strap assembly (204) to the head rest bracket (202).

As shown in FIG. 6B, the head rest (5) is uninstalled from the top (8) of the seat (9) of the vehicle (3). The openings (218) and slot (220) of the head rest bracket (202) are positioned over the corresponding openings (not shown) for the left and right spokes (6, 7) of the head rest (5) on the top (8) of the seat (9). The head rest (5) is then reinstalled by inserting the left and right spokes (6, 7) into their openings.

The top and/or bottom portions (232, 234) of the strap (222) are pulled through the adjustable buckle (226) to shorten or increase the length of the strap (222). The hook (228) at the bottom end (236) of the strap (222) is then attached to the lower anchor (11) hidden within the crack (13) of the seat (9). To ensure that the strap (222) is taut, the length of the strap (222) can be further adjusted using the adjustable buckle (226).

The track follower (260, 310, 314) is positioned at the appropriate height for the passenger to rest the neck and head against the padded body (298) in a natural, comfortable position, or in a supported position (as when the passenger falls asleep), minimizing the risk of head bobbing or neck strain. The positioning of the track follower (260, 310,314) and thus the padded body (298) can be easily and readily adjusted for either adults or children. In some embodiments shown in FIGS. 13B-C, the position of the track follower (260) is selectively adjusted by manipulating the fingers (286) to engage any pair of opposed notches (276) along the length of the track (258). In some embodiments as shown in FIGS. 15A-B, the positioning of the buckle track follower (310) or fabric track follower (314) is adjusted by shortening or increasing the length of the strap (222) using the adjustable buckle (226).

The ribs (292, 294) of the track follower (260, 312, 314) space the aperture plate (302) away from the track follower (260, 312, 314) to allow room for the hair protection casing (318). In some embodiments as shown in FIGS. 16A-E, the hair protection casing (318) is placed on the track assembly (206) to encase the first and second ends (268, 270), rear surface (290), and notches (276) of the track (258) for preventing entanglement of the user's hair with components of the track follower (260, 310, 314).

In some embodiments, the flap (308) is detached from the back (304) of the padded body (298). To secure the padded body (298) to the track follower (260, 310, 314), the apertures (306) of the aperture plate (302) are aligned with the snap tabs (294, 312, 316) of the track follower (260, 310, 314) and pressed over the snap tabs (294, 312, 316) to snap-fit the padded body (298) to the track follower (260, 310, 314).

After use, the padded body (298) can be easily and quickly detached by pulling on the padded body (298), thereby removing the snap tabs (294, 312, 316) of the track follower (260, 310, 314) from within the apertures (306) of the padded body (298). The flap (308) can be resecured to the back (304) of the padded body (298) to allow the cushioned pillow assembly (100) to be used as a toy for play by the child.

The cushioned pillow assembly (100) is interchangeable, being conveniently changed out as desired as appropriate for either adults (e.g., larger sizes, branded sport pillows) or children (e.g., smaller sizes, animals, popular animated characters). In some embodiments, the head support (200) may be packaged in a kit form including one particular design of the cushioned pillow assembly (100), the head rest bracket (202), strap assembly (204), and track assembly (206). Other designs of the cushioned pillow assembly (100) may be purchased separately for attachment to the originally purchased.

The inventive subject matter is not to be restricted except in the scope of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. As used herein and in the appended claims, the singular forms “a,” “an,” and “the” include plural referents unless the context clearly dictates otherwise. In addition, the components and steps described in the above embodiments and figures are merely illustrative and do not imply that any particular component or step is a requirement of a claimed embodiment.

What is claimed is:

1. A head support for a seat comprising:
a cushioned pillow assembly comprising a padded body and a locking mechanism; and
a bracket assembly mountable to the seat.

2. The head support of claim 1, wherein the padded body comprises a casing and a fill stuffed within the casing.

3. The head support of claim 1, wherein the locking mechanism comprises a peg and a slidable plate, the peg being anchored within the padded body and extending outwardly from the padded body to the slidable plate.

4. The head support of claim 3, wherein the slidable plate defines a central aperture for receiving the peg therethrough, and is configured to be inserted into, or removed from, the bracket assembly.

5. The head support of claim 4, wherein the bracket assembly comprises a track, a top portion, and a flexible prong.

6. The head support of claim 5, wherein the track comprises a flat body having a front surface, a back surface, opposing first and second ends, opposing first and second lengthwise sides, and a plate-retaining mechanism positioned on the front surface of the body.

7. The head support of claim 6, wherein the plate-retaining mechanism comprises a pair of rails defining a channel extending from the first end to the second end of the track.

8. The head support of claim 7, wherein the track defines a plurality of openings spaced apart and extending between the first and second ends along the length of the track, each opening being configured to engage the peg.

9. The head support of claim 5, wherein the top portion is positioned perpendicularly and horizontally relative to the track, the top portion being configured with a length sufficient to span a width of the seat.

10. The head support of claim 5, wherein the flexible prong is positioned at an angle less than perpendicular and vertically relative to the top portion, the flexible prong being curved and configured with a length sufficient to span a portion of the seat.

11. The head support of claim 1, further comprising a strap assembly supporting a track assembly mounted thereon.

12. The head support of claim 11, wherein the bracket assembly comprises a head rest bracket comprising an elongated body defining a plurality of openings and a slot for receiving spokes of a vehicle head rest therethrough, and first and second ends supporting first and second tabs for attaching the strap assembly.

13. The head support of claim 12, wherein the strap assembly comprises a strap, a snap fitting for removably attaching the strap assembly to the head rest bracket, an adjustable buckle for shortening or lengthening the strap, and a hook for securing the strap to an anchor of the seat.

14. The head support of claim 13, wherein the snap fitting is selected from:
(a) a bracket defining a central window configured to receive the first or second tabs of the head rest bracket therethrough;
(b) a cantilever snap comprising a cantilever beam and an overhang at the end of the beam;
(c) a cantilever snap comprising a plate, a protrusion configured for insertion into a first recess defined by the head rest bracket, and a rod configured for insertion into a second recess defined by the head rest bracket; or
(d) the cantilever snap of (c) wherein the plate comprises a first magnet attractable to a second magnet with the first recess of the head rest bracket.

15. The head support of claim 11, wherein the track assembly comprises a track and a track follower, the track comprising a flat body having a front surface, a back surface, first and second ends, and first and second sides defining notches.

16. The head support of claim 15, further comprising attachment means and locking members for securing the track to the strap.

17. The head support of claim 15, wherein the track follower is mountable to the track for translation along the track in a direction generally parallel to a longitudinal centerline of the track, the position of the track follower being selectively adjustable.

18. The head support of claim 17, wherein the track follower is selected from:
(a) the track follower defining a pair of opposed inverted “L”-shaped slots, a pair of opposed fingers for engaging the notches, and a pair of opposed channels disposed on a rear surface for engaging the track, and a pair of outwardly extending opposed snap tabs on a front surface for attaching the cushioned pillow assembly;
(b) a buckle track follower; or
(c) a fabric track follower.

19. The head support of claim 18, wherein the locking mechanism comprises an aperture plate positioned on a back of the padded body, and defining one or more apertures for receiving the snap tabs of the track follower, and optionally a flap for concealing the aperture plate.

20. The head support of claim 18, further comprising a hair protection casing comprising an elongated body, curved ends encasing the first and second ends of the track, curved side walls encasing the sides of the track, and a rim extending around the body of the track, the hair protection casing defining an elongated window having a raised inner edge abutting the snap tabs.
